(19) United States
(12) Patent Application Publication
(10) Pub. No.: US 2014/0019123 A1
(43) Pub. Date: Jan. 16, 2014

(54) METHOD AND DEVICE FOR GENERATING VOCAL ORGANS ANIMATION USING STRESS OF PHONETIC VALUE

(71) Applicant: Bong-Rae Park, Seoul (KR)

(72) Inventor: Bong-Rae Park, Seoul (KR)

(73) Assignees: CLUSOFT CO., LTD., Seoul (KR); Bong-Rae PARK, Seoul (KR)

(21) Appl. No.: 14/007,809

(22) PCT Filed: Apr. 13, 2011
(86) PCT No.: PCT/KR2011/002610

§ 371 Date: Sep. 26, 2013

(30) Foreign Application Priority Data
Mar. 28, 2011 (KR) 10-2011-0027666

(51) Int. Cl. G10L 15/00

(52) U.S. Cl. CPC G10L 15/005
USPC 704/9

(57) ABSTRACT

Disclosed are a method and a device for generating a vocal organ animation using a stress of a phonetic value, the method and the device which generate a more accurate and a more natural vocal organ animation by applying a pronunciation form of a native speaker, which changes according to the stress of the phonetic values constituting a word. The proposed device for generating a vocal organ animation using the stress of a phonetic value: generates phonetic value configuration data having applied thereto a detailed phonetic value for each of the stresses by detecting from voice information, and allocating to a corresponding phonetic value, a phonation length and stress information of each of the phonetic values included in text information; and generates a vocal organ animation corresponding to the words included in the text information by assigning pronunciation form information detected on the basis of the phonetic value configuration data.

### TECHNICAL FIELD

The present invention relates, in general, to an apparatus and method for generating a vocal organ animation using the stress (accent) of phonetic values and, more particularly, to an apparatus and method for generating a vocal organ animation using the stress of phonetic values, which generate a vocal organ animation by reflecting the pronunciation form of a native speaker.

### BACKGROUND ART

With the acceleration of globalization, needs for foreign language ability have increased. In this situation, in order to rapidly learn a foreign language, there is a need to be primarily accustomed to the pronunciation of the corresponding language. The reason for this is that the pronunciation of a native speaker can be understood only when one is sufficiently accustomed to the pronunciation of the corresponding language, and that various phrases or sentences can be more effectively and efficiently learned only in a situation in which the pronunciation of the native speaker must be able to be understood. Also, the reason for this is that conversation with a native speaker is possible only when using the corresponding language with accurate pronunciation, thus enabling the language to be learned via conversation.

It is known that, in the course of learning a language, children become familiar with phonetic features, particularly, segmentation of the corresponding language before being born, and then gradually learn the meaning and grammar of the language after being born. Further, when children are around 10 years old, the elements of the vocal organs are fixated to vernacular voice patterns, and then begin to have difficulty in learning foreign languages.

However, since current foreign language education is focused on word-, phrase-, and sentence-centered education even in a state in which people are not accustomed to the phonetic features of a foreign language and have difficulty in phonetic segmentation, it is not easy to hear and use a transformed sentence if the corresponding sentence is slightly transformed even in the case of an accustomed sentence. In particular, elements organizing a language cannot be easily segmented in a quickly pronounced sentence, and thus it is difficult to hear the sentence and the pronunciation of the sentence is also very unnatural.

Accordingly, educational institutions and educational businesses have developed various solutions to correct pronunciation, and two representatives thereof related to the present invention are introduced as follows.

One is a solution to present a process in which the elements of vocal organs are moved while each sound is pronounced. For this, there are solutions, such as Pronunciation Power which is a product made in the United States, Tell Me More which is a product made in France, and a solution serviced over the Internet at the University of Iowa in the United States. These solutions show the process of pronunciation of basic phonemes of English via the change of a mouth shape from the front of the face and the change of the internal shape of the mouth from the side of the face, thus helping in understanding how the corresponding phonetic value (phoneme) is pronounced.

The other is a solution to present a pronounced voice in the form of a speech wave image and to compare similarity of the corresponding voice. Products for this solution include Pronunciation Power which is a product made in the United States, Tell Me More which is a product made in France, and Root English which is a product of EONEO INC. in Korea. These products are characterized in that they show speech waves uttered by a native speaker and by a learner for a sentence or the like and the degree of similarity between the speech waves and compare the speech waves with each other, and the learner is inducted to utter similarly to the native speaker.

The above two solutions are useful in that they provide a means for allowing a learner to understand principles of pronunciation and determine whether his or her pronunciation is correct. However, there still remains a room for improvement in that the solutions are excessively simple or are difficult to understand.

A scheme for presenting the movement of the vocal organs is configured to previously construct a process for pronouncing basic phonemes (consonants and vowels of the corresponding language) in the form of an animation of two-dimensional (2D) images and merely individually show the animation, thus not only making it impossible to make learners understand that even in the same phoneme, pronunciation procedures may be variously displayed depending on a neighboring phoneme and depending on stress or speed upon utterance, but also making it difficult to induce continuous correction of pronunciation throughout the overall language learning process because the procedures of learning pronunciation are separated during a process for learning practical words, phrases, and sentences.

Further, in the scheme for comparing speech waves, normal learners cannot easily understand speech waves themselves, and an intuitive method of learning the principles of pronunciation is not provided. Furthermore, the scheme of performing comparison with the speech waveform of a native speaker may deteriorate reliability because, even if a learner correctly pronounces a sound, it may be different from that of the native speaker and a negative evaluation may then be presented.

In order to solve the above problems, there is an apparatus and method for displaying pronunciation information filed by the present applicant and registered (disclosed in Korean Patent No. 10-1015261, hereinafter referred to as a “registered patent”). This registered patent is configured to generate a movement process of the vocal organs in the form of an animation and display the animation in order to effectively support the correction of pronunciation in language education. This technology is configured to include pieces of articulator state information corresponding to respective phonetic values, generate an animation of vocal organs based on the pieces of corresponding articulator state information if successive phonetic values are given, and display the animation on a screen, thus providing information about the pronunciation forms of the native speaker to foreign language learners. Furthermore, the registered patent is configured to, even in the case of the same word, reflect the pronunciation phenomenon, such as speaking speed, abbreviation, shortening, or omission, and generate an animation of the vocal organs close to those of the native speaker.

However, articulators have a tendency to previously prepare a subsequent sound when a specific sound is uttered in continuous pronunciation, and this is linguistically called ‘the economy of pronunciation.’ For example, when the /r/ sound appears subsequent to preceding sounds of /b/, /p/, /m/, /f/, and /v/, which seem to be unrelated to the action of the tongue in English, the tongue has a tendency to previously prepare pronunciation of the /r/ sound during the pronunciation of preceding sounds. Further, even if pronunciation of sounds requiring the direct actions of the tongue in English appears continuously, there is a tendency for the pronunciation of the current sound to differ from that of a standard phonetic value in conformity with the pronunciation of a subsequent sound so that the subsequent sound can be easily pronounced.

However, the present applicant found that such economy of pronunciation was not effectively incorporated into the registered patent. That is, the registered patent does not sufficiently incorporate the pronunciation form of a native speaker changing according to an adjacent phonetic value even in the same phonetic value into an animation, and then there is a problem in that a difference is present between the actual pronunciation form of the native speaker and an animation of the vocal organs.

In order to solve the above problem, there is an apparatus and method for generating a vocal organ animation filed by the present applicant (disclosed in Korean Patent Application No. 10-2010-0051369, hereinafter referred to as a ‘filed patent’). This filed patent generates a vocal organ animation by reflecting a procedure in which each sound is pronounced differently according to the pronunciation of an adjacent sound.

### DISCLOSURE

### Technical Problem

An object of the present invention is to provide an apparatus and method for generating a vocal organ animation using the stress of phonetic values, which generate a more accurate and natural animation of vocal organs by reflecting the pronunciation form of a native speaker that changes depending on the stress of phonetic values constituting a word.

### Technical Solution

In accordance with an embodiment of the present invention to accomplish the above objects, there is provided an apparatus for generating a vocal organ animation using stress of phonetic values, including a phonetic value configuration data generation unit for detecting utterance lengths and stress information of respective phonetic values constituting words included in text information from voice information input together with the text information, allocating the detected utterance lengths to the respective phonetic values constituting the words included in the text information, and then generates phonetic value configuration data; a stress-based phonetic value application unit for allocating stress information detected by the phonetic value configuration data generation unit to the generated phonetic value configuration data, and applying stress-based detailed phonetic values to the respective phonetic values; a pronunciation form detection unit for detecting pieces of pronunciation form information corresponding to detailed phonetic values included in the phonetic value configuration data to which the stress-based detailed phonetic values are applied; and an animation generation unit for assigning the pieces of detected pronunciation form information to the respective phonetic values constituting the words included in the text information, and then generating a vocal organ animation corresponding to the words included in the text information.

In accordance with an embodiment of the present invention to accomplish the above objects, there is provided an apparatus for generating a vocal organ animation using stress of phonetic values, including a phonetic value configuration data generation unit for allocating input utterance lengths to respective phonetic values constituting words included in text information and then generating phonetic value configuration data; a stress-based phonetic value application unit for allocating input stress information to the phonetic value configuration data, and applying the stress-based detailed phonetic values to the respective phonetic values; a pronunciation form detection unit for detecting pieces of pronunciation form information corresponding to detailed phonetic values included in the phonetic value configuration data to which the stress-based detailed phonetic values are applied; and an animation generation unit for assigning the pieces of detected pronunciation form information to the respective phonetic values constituting the words included in the text information, and then generating a vocal organ animation corresponding to the words included in the text information.

In accordance with an embodiment of the present invention to accomplish the above objects, there is provided an apparatus for generating a vocal organ animation using stress of phonetic values, including a phonetic value information storage unit for storing utterance lengths of a plurality of phonetic values; a stress-based phonetic value information storage unit for storing pieces of stress information of the plurality of phonetic values; a phonetic value configuration data generation unit for detecting utterance lengths of the respective phonetic values constituting the words included in the text information from the phonetic value information storage unit, allocating the detected utterance lengths, and then generates the phonetic value configuration data; a stress-based phonetic value application unit for detecting the stress information of the respective phonetic values constituting the words included in the text information from the stress-based phonetic value information storage unit, allocating the detected stress information to the generated phonetic value configuration data, and applying the stress-based detailed phonetic values to the respective phonetic values; a pronunciation form detection unit for detecting pieces of pronunciation form information corresponding to detailed phonetic values included in the phonetic value configuration data to which the stress-based detailed phonetic values are applied; and an animation generation unit for assigning the pieces of detected pronunciation form information to the respective phonetic values constituting the words included in the text information, and then generating a vocal organ animation corresponding to the words included in the text information.

In accordance with an embodiment of the present invention to accomplish the above objects, there is provided an apparatus for generating a vocal organ animation using stress of phonetic values, including an input unit for inputting utterance lengths and stress information of respective phonetic values constituting words included in the text information; a phonetic value configuration data generation unit for allocating the input utterance lengths to the respective phonetic values constituting the words included in the text information and then generates phonetic value configuration data; a stress-based phonetic value application unit for allocating input stress information to the phonetic value configuration data, and applying the stress-based detailed phonetic values to the respective phonetic values; a pronunciation form detection unit for detecting pieces of pronunciation form information corresponding to detailed phonetic values included in the phonetic value configuration data to which the stress-based detailed phonetic values are applied; and an animation generation unit for assigning the pieces of detected pronunciation form information to the respective phonetic values constituting the words included in the text information, and then generating a vocal organ animation corresponding to the words included in the text information.

The apparatus may further include a pronunciation form information storage unit for storing a plurality of pieces of pronunciation form information for a plurality of phonetic values so that one or more pieces of pronunciation form information having pieces of different stress information are associated with each of the plurality of phonetic values, wherein the pronunciation form detection unit is configured to detect pronunciation form information having stress information having a smallest stress difference from stress information of each phonetic value, among the one or more pieces of pronunciation form information associated with each phonetic value, as pronunciation form information of the phonetic value.

The apparatus may further include a pronunciation form information storage unit for storing pronunciation form information so that pieces of pronunciation form information having stress information are associated with each of a plurality of phonetic values, wherein the pronunciation form detection unit detects a stress difference between the stress information of the phonetic values included in the phonetic value configuration data and stress information of the pieces of pronunciation form information stored in the storage unit, generates pronunciation form information depending on the stress difference, and sets generated pronunciation form information as pronunciation form information of a corresponding phonetic value.

The apparatus may further include a transition section assignment unit for assigning a part of utterance lengths of two neighboring phonetic values included in the phonetic value configuration data as a transition section between the two phonetic values.

In accordance with an embodiment of the present invention to accomplish the above objects, there is provided a method of generating a vocal organ animation using stress of phonetic values, including detecting the utterance lengths and stress information of the respective phonetic values constituting the words included in the text information; allocating utterance lengths corresponding to respective phonetic values constituting words included in text information to corresponding phonetic values and then generating phonetic value configuration data; allocating pieces of stress information corresponding to respective phonetic values included in the generated phonetic value configuration data and applying stress-based detailed phonetic values to the phonetic value configuration data; detecting pieces of pronunciation form information corresponding to the stress-based detailed phonetic values included in the phonetic value configuration data to which the stress-based detailed phonetic values are applied; and assigning the pieces of detected pronunciation form information to the respective phonetic values, and then generating a vocal organ animation corresponding to the words included in the text information.

Detecting the utterance lengths and stress information comprises any one of detecting the utterance lengths and the stress information from voice information input together with the text information; and detecting utterance lengths and stress information corresponding to the respective phonetic values constituting the words included in the text information from a plurality of pre-stored phonetic values.

In accordance with an embodiment of the present invention to accomplish the above objects, there is provided a method of generating a vocal organ animation using stress of phonetic values, including inputting utterance lengths and stress information of the respective phonetic values constituting the words included in the text information; generating the phonetic value configuration data is configured to allocate input utterance lengths of the respective phonetic values to corresponding phonetic values, and then generate the phonetic value configuration data; applying the stress-based detailed phonetic values is configured to allocate pieces of detected stress information of the phonetic values to the respective phonetic values included in the input phonetic value configuration data and apply the stress-based detailed phonetic values to the phonetic value configuration data; detecting pieces of pronunciation form information corresponding to the stress-based detailed phonetic values included in the phonetic value configuration data to which the stress-based detailed phonetic values are applied; and assigning the pieces of detected pronunciation form information to the respective phonetic values, and then generating a vocal organ animation corresponding to the words included in the text information.

Detecting the pronunciation form information is configured to detect pronunciation form information having stress information having a smallest stress difference from stress information of each phonetic value, among one or more pieces of pronunciation form information associated with each phonetic value, as pronunciation form information of the corresponding phonetic value, or generate pronunciation form information depending on a stress difference between the stress information of the phonetic values included in the phonetic value configuration data and stress information of pieces of pre-stored pronunciation form information, and set the generated pronunciation form information as pronunciation form information of the corresponding phonetic value.

The method may further include assigning a part of utterance lengths of two neighboring phonetic values among phonetic values included in any one of phonetic value configuration data to which utterance lengths are allocated and phonetic value configuration data to which stress-based detailed phonetic values are applied, as a transition section between the two phonetic values.

### Advantageous Effects

In accordance with the present invention, an apparatus and method for generating a vocal organ animation using the stress of phonetic values are advantageous in that a vocal organ animation is generated by reflecting the pronunciation form of a native speaker that changes depending on the stress of phonetic values constituting a word, thus generating a vocal organ animation very close to the pronunciation form of the native speaker.

Further, the apparatus and method for generating a vocal organ animation using the stress of phonetic values are advantageous in that the movement process of the vocal organs is generated in the form of an animation and is then displayed, thus providing an environment in which a language learner can intuitively understand the pronunciation principles of a target language and a difference in pronunciation between a native speaker and the learner, and in which the learner can be naturally familiar with the pronunciation of all sounds of the corresponding language during a procedure for variously learning from basic phonetic values to sentences.

Furthermore, the apparatus and method for generating a vocal organ animation using the stress of phonetic values are advantageous in that an animation is generated based on pieces of pronunciation form information classified for respective articulators, such as lips, tongue, nose, uvula, palate, teeth, and gums, thus enabling a more accurate and natural vocal organ animation to be implemented.

### DESCRIPTION OF DRAWINGS

FIGS. 1 and 2 are diagrams showing an apparatus for generating a vocal organ animation using the stress of phonetic values according to an embodiment of the present invention;

FIGS. 3 and 4 are diagrams showing the phonetic value configuration data generation unit of FIGS. 1 and 2;

FIG. 5 is a diagram showing the transition section assignment unit of FIG. 2;

FIGS. 6 and 7 are diagrams showing the stress-based phonetic value application unit of FIGS. 1 and 2;

FIGS. 8 and 9 are diagrams showing the pronunciation form information storage unit of FIGS. 1 and 2;

FIG. 10 is a diagram showing a modification of the apparatus for generating a vocal organ animation using the stress of phonetic values according to an embodiment of the present invention;

FIG. 11 is a diagram showing a method of generating a vocal organ animation using the stress of phonetic values according to an embodiment of the present invention; and

FIG. 12 is a diagram showing a method of generating a vocal organ animation using the stress of phonetic values according to another embodiment of the present invention.

### BEST MODE

Preferred embodiments of the present invention will be described in detail below with reference to the accompanying drawings to such an extent that those skilled in the art can easily implement the technical spirit of the present invention. Reference now should be made to the drawings, in which the same reference numerals are used throughout the different drawings to designate the same or similar components. In the following description, redundant descriptions and detailed descriptions of known elements or functions that may unnecessarily make the gist of the present invention obscure will be omitted.

First, terms used in detailed description of an apparatus and method for generating a vocal organ animation using the stress of phonetic values according to an embodiment of the present invention are defined as follows.

A phonetic value denotes the sound value of each phoneme constituting a word. That is, a phonetic value corresponds to the pronunciation of each phoneme constituting a word, and refers to a phonetic phenomenon occurring due to unitary actions caused by the basic condition of vocal organs.

Phonetic value configuration data denotes a list of phonetic values constituting a word.

A detailed phonetic value denotes a sound value or a variation sound for each phonetic value actually uttered according to the adjacent phonetic value or stress, and each phonetic value has one or more detailed phonetic values.

A transition section denotes a time interval for a process in which a first phonetic value at a previous position makes a transition to a second phonetic value at a subsequent position when a plurality of phonetic values are continuously uttered.

Vocal organ information denotes information about the shape of an articulator when a detailed phonetic value or an articulation symbol is uttered. That is, the vocal organ information denotes state information about the state of movement of each vocal organ when a phonetic value is pronounced. Here, vocal organs include individual regions of a body used to utter a sound, such as lips, tongue, nose, uvula, palate, teeth, and gums.

An articulation symbol denotes information representing the form of each articulator by an identifiable symbol when a detailed phonetic value is uttered by each articulator. Each articulator denotes body organs used to make a sound, such as lips, tongue, nose, uvula, palate, teeth, and gums.

Articulation configuration data consists of a list that includes unit information which is made up of each articulation symbol and the utterance length and transition section of the articulation symbol form. And Articulation configuration data is generated based on phonetic value configuration data.

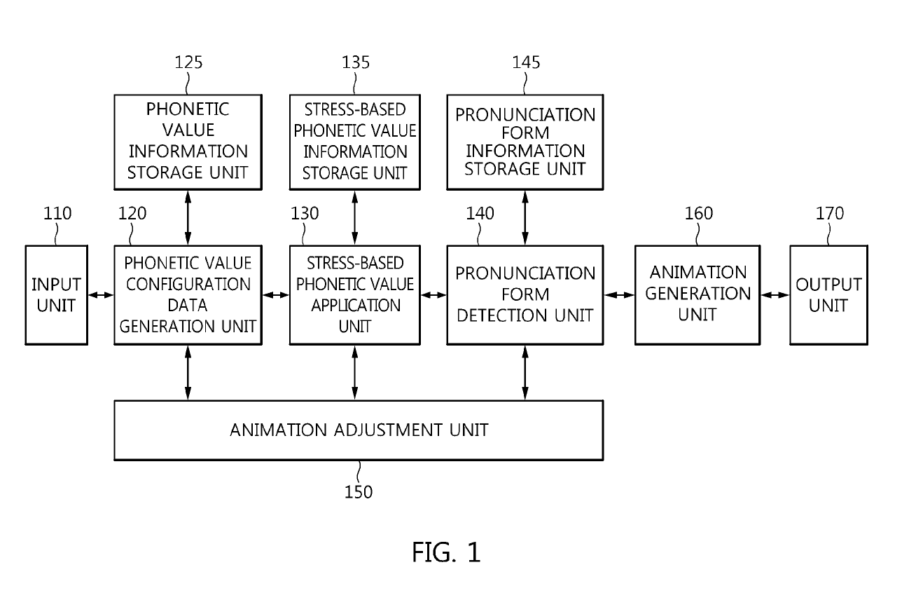

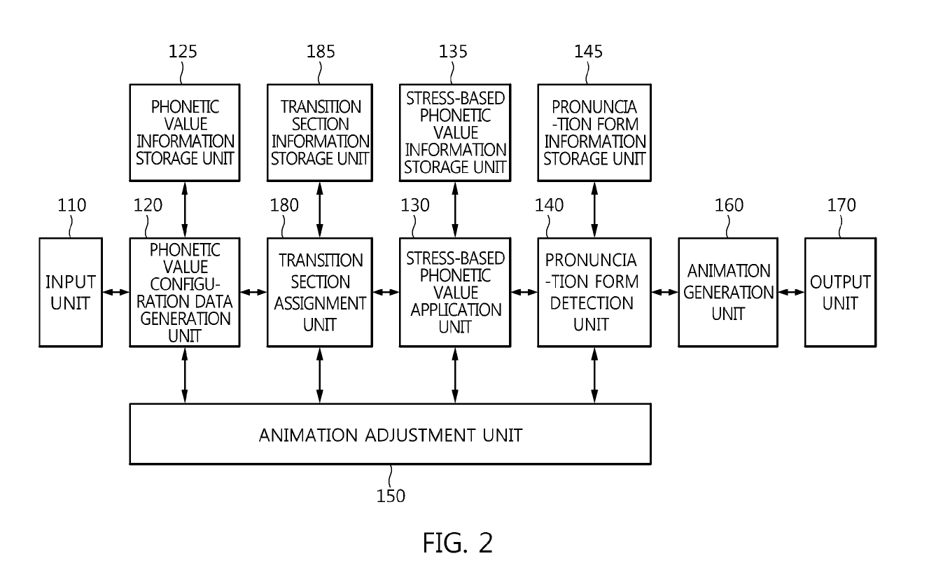

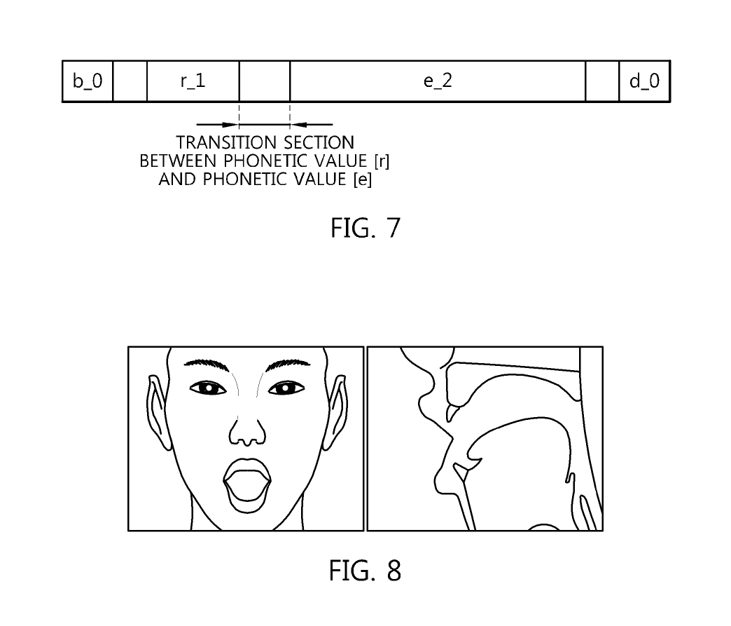

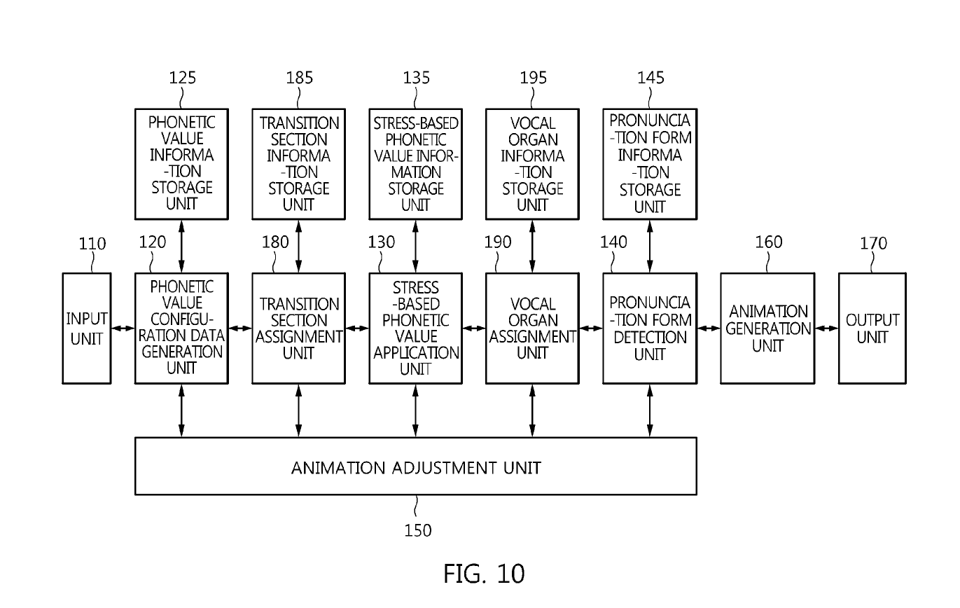

Hereinafter, an apparatus for generating a vocal organ animation using the stress of phonetic values according to an embodiment of the present invention will be described in detail with reference to the attached drawings. FIGS. 1 and 2 are diagrams showing an apparatus for generating a vocal organ animation using the stress of phonetic values according to an embodiment of the present invention. FIGS. 3 and 4 are diagrams showing the phonetic value configuration data generation unit of FIGS. 1 and 2, FIG. 5 is a diagram showing the transition section assignment unit of FIG. 2, and FIGS. 6 and 7 are diagrams showing the stress-based phonetic value application unit of FIGS. 1 and 2, and FIGS. 8 and 9 are diagrams showing the pronunciation form information storage unit of FIGS. 1 and 2. FIG. 10 is a diagram showing a modification of the apparatus for generating a vocal organ animation using the stress of phonetic values according to an embodiment of the present invention.

As shown in FIG. 1, the apparatus for generating a vocal organ animation using the stress of phonetic values includes an input unit 110, a phonetic value configuration data generation unit 120, a phonetic value information storage unit 125, a stress-based phonetic value application unit 130, a stress-based phonetic value information storage unit 135, a pronunciation form detection unit 140, a pronunciation form information storage unit 145, an animation adjustment unit 150, an animation generation unit 160, and an output unit 170. As shown in FIG. 2, the apparatus for generating a vocal organ animation using the stress of phonetic values may further include a transition section assignment unit 180 and a transition section information storage unit 185.

The input unit 110 inputs text information and voice information from a user. That is, the input unit 110 inputs text information including a phoneme, a syllable, a word, a phrase, a sentence, or the like from the user. The input unit 110 inputs voice information corresponding to the text information. Here, the input unit 110 inputs voices made when the user utters the text information as voice information. Of course, the input unit 110 may input text information and voice information from a specific device or a server.

The input unit 110 may input the utterance length and stress information of each phonetic value from the user. That is, the input unit 110 is configured to, when only text information is input from the user, input the utterance lengths and stress information of respective phonetic values included in the text information from the user so as to generate phonetic value configuration data.

The phonetic value configuration data generation unit 120 generates phonetic value configuration data including the utterance lengths of respective phonetic values based on the input text information and voice information. For this, the phonetic value configuration data generation unit 120 detects the utterance lengths of respective phonetic values constituting words included in the input text information. In this case, the phonetic value configuration data generation unit 120 detects the utterance lengths of the respective phonetic values via the speech analysis of the voice information input together with the text information.

The phonetic value configuration data generation unit 120 may also detect the utterance lengths of respective phonetic values from the phonetic value information storage unit 125. That is, the phonetic value configuration data generation unit 120 is configured to, when text information is input from the input unit 110, check individual words arranged in the text information, and detect the utterance lengths of phonetic values included in each word from the phonetic value information storage unit 125. For example, when the word ‘bread’ is input from the input unit 110, the phonetic value configuration data generation unit 120 detects /bred/ as the phonetic value information of ‘bread’ from the phonetic value information storage unit 125. The phonetic value configuration data generation unit 120 detects the utterance lengths of the respective phonetic values /b/, /r/, /e/, and /d/ included in the detected phonetic value information from the phonetic value information storage unit 125.

The phonetic value configuration data generation unit 120 generates phonetic value configuration data by applying the detected utterance lengths of the phonetic values to the respective phonetic values included in the text information. The phonetic value configuration data generation unit 120 may also generate the phonetic value configuration data by applying the utterance lengths of the phonetic values input through the input unit 110 to the respective phonetic values included in the text information. That is, the phonetic value configuration data generation unit 120 generates phonetic value configuration data including one or more phonetic values corresponding to the text information and the utterance lengths of the respective phonetic values. For example, as shown in FIG. 3, the phonetic value configuration data generation unit 120 generates phonetic value configuration data including the utterance lengths of the respective phonetic values.

The phonetic value configuration data generation unit 120 may detect pieces of stress information of the respective phonetic values constituting words included in the input text information. That is, the phonetic value configuration data generation unit 120 may divide the section of voice information for respective phonetic values depending on the detected utterance lengths of the respective phonetic values, measure the average energy or pitch value of the corresponding section, and extract pieces of stress information of respective phonetic values. For example, as shown in FIG. 4, when text information and voice information about ‘She was a queen’ are input through the input unit 110, the phonetic value configuration data generation unit 120 divides the section of the voice information for respective phonetic values. The phonetic value configuration data generation unit 120 measures average energy or a pitch value in the section corresponding to the utterance length of the phonetic value /aa/ of the word ‘was.’ The phonetic value configuration data generation unit 120 extracts the measured average energy or the pitch value as the stress information of the phonetic value /aa/. Of course, the phonetic value configuration data generation unit 120 may detect pieces of stress information about the respective phonetic values from the phonetic value information storage unit 125.

The phonetic value information storage unit 125 stores pieces of phonetic value information for words. That is, the phonetic value information storage unit 125 stores pieces of phonetic value information for words, which include the pronunciation lengths of the respective phonetic values included in each word. For example, the phonetic value information storage unit 125 stores /bred/ as phonetic value information about the word ‘bread’. The phonetic value information storage unit 125 stores information about the utterance lengths of the respective phonetic values included in the phonetic value information. The phonetic value information storage unit 125 stores the phonetic values /b/, /r/, /e/, and /d/ included in /bred/ and pieces of utterance length information of the respective phonetic values so that the phonetic values are associated with the pieces of utterance length information. Here, the typical or representative utterance length of the phonetic values is generally about 0.2 second in the case of vowels and about 0.04 second in the case of consonants, wherein vowels have different utterance lengths depending on a long vowel, a monophthong, and a diphthong, and consonants have different utterance lengths depending on a voiced sound, an unvoiced sound, a fricative, an affricate, a liquid, and a nasal. The phonetic value information storage unit 125 stores information about different utterance lengths depending on the types of such vowels or consonants.

In this case, the phonetic value information storage unit 125 may further store pieces of stress information about the respective phonetic values. In detail, the phonetic value information storage unit 125 stores one or more pieces of stress information having different stresses for each phonetic value. That is, there may occur a case where a phonetic value has different stresses due to phonetic values located previous to and subsequent to the phonetic value or the accent of the phonetic values. Therefore, the phonetic value information storage unit 125 stores each phonetic value to include all stresses with which the phonetic value can be pronounced. Of course, the phonetic value information storage unit 125 may store only stress information corresponding to the representative stress of each phonetic value.

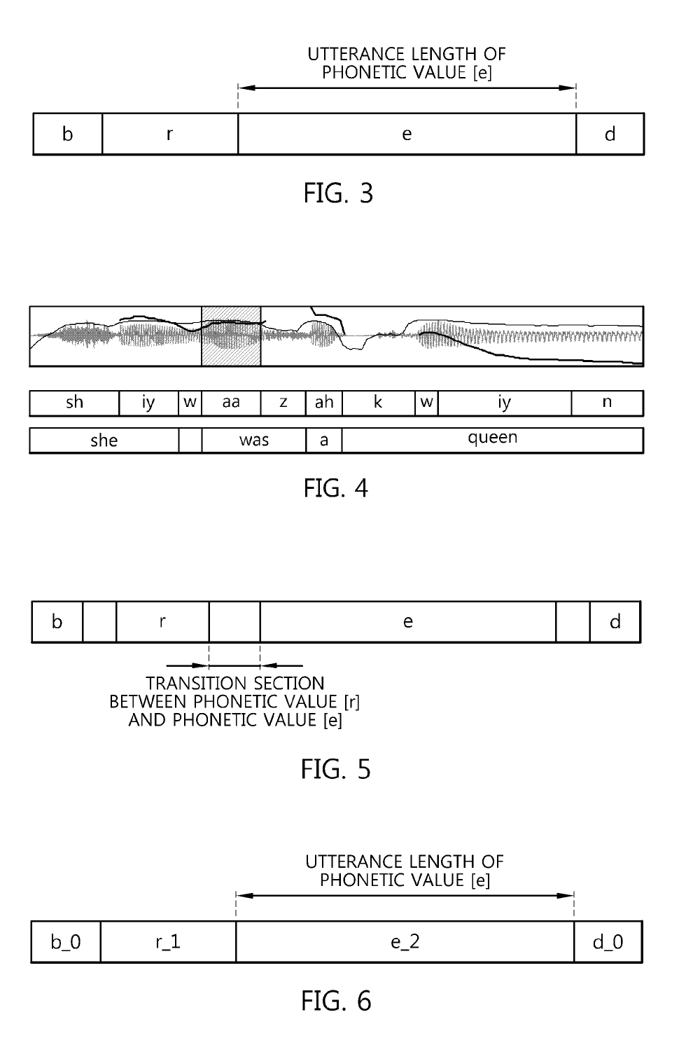

The transition section assignment unit 180 assigns transition sections to the phonetic value configuration data generated by the phonetic value configuration data generation unit 120, based on the pieces of transition section information for respective adjacent phonetic values, stored in the transition section information storage unit 185. That is, the transition section assignment unit 180 assigns transition sections between phonetic values included in the generated phonetic value configuration data, based on the information stored in the transition section information storage unit 185. In this case, the transition section assignment unit 180 assigns part of the utterance lengths of neighboring phonetic values, to which a transition section is assigned, as the utterance length of the transition section. For example, the transition section information storage unit 185 stores information about a transition section corresponding to a first uttered phonetic value and a second uttered phonetic value, as given by the following Table 1. The transition section assignment unit 180 inputs phonetic value configuration data about ‘bred’ from the phonetic value configuration data generation unit 120. The transition section assignment unit 180 sets a transition section between phonetic values /b/ and /r/ as t1, sets a transition section between phonetic values /r/ and /e/ as t2, and sets a transition section between phonetic values /e/ and /d/ as t3, on the basis of the following Table 1. In this case, as shown in FIG. 5, the transition section assignment unit 180 assigns part of the utterance lengths of neighboring phonetic values as the utterance length of a transition section. Accordingly, the utterance length of the phonetic values /b/, /r/, /e/, and /d/ is reduced.

TABLE 1

| Neighboring phonetic value information | | Transition section |
|---|---|---|
| First uttered sound | Second uttered sound | information |
| B | r | t1 |
| R | e | t2 |
| E | d | t3 |
| T | s | t4 |
| T | o | t5 |

The transition section assignment unit 180 is configured to, when voice information is input from the input unit 110, correct and apply transition section information extracted from the transition section storage unit to be suitable for the actual utterance lengths of two neighboring phonetic values that are previous to and subsequent to the transition section because the actual utterance lengths of phonetic values extracted via speech recognition may differ from the utterance lengths stored in the phonetic value information storage unit 125. That is, the transition section assignment unit 180 is configured to, when the actual utterance length of two neighboring phonetic values is longer than a typical utterance length, assign a transition section between the two phonetic values as a long transition section, and when the actual utterance length is shorter than the typical utterance length, assign the transition section as a short transition section.

The transition section information storage unit 185 stores information about the time required during a procedure in which utterance makes a transition from each phonetic value to an adjacent subsequent phonetic value. That is, the transition section information storage unit 185 stores time information for an utterance transition section in which a transition from a first uttered sound to a second uttered sound is made when a plurality of phonetic values are continuously uttered. The transition section information storage unit 185 stores different pieces of transition section time information depending on an adjacent phonetic value even in the case of the same phonetic value.

The stress-based phonetic value application unit 130 allocates the detected stress information to the generated phonetic value configuration data, and then applies stress-based detailed phonetic values to the respective phonetic values. The stress-based phonetic value application unit 130 may allocate the stress information input through the input unit 110 to the phonetic value configuration data and may apply stress-based detailed phonetic values to the respective phonetic values. In this case, the stress-based phonetic value application unit 130 applies pieces of stress information of respective phonetic values detected (or input) by the phonetic value configuration data generation unit 120 to the respective phonetic values of the phonetic value configuration data to which utterance lengths have been allocated, thus reconfiguring the phonetic value configuration data into phonetic value configuration data to which stress-based detailed phonetic values are applied. For example, the phonetic value configuration data generation unit 120 is assumed to detect 0, 1, 2, and 0 as the stress information of the respective phonetic values /b/, /r/, /e/, and /d/ included in the word ‘bread.’ In this case, when transition sections are not applied to the phonetic value configuration data, the stress-based phonetic value application unit 130 reconfigures the phonetic value configuration data into phonetic value configuration data to which stress-based detailed phonetic values are applied, by incorporating the stresses of the respective phonetic values into the phonetic value configuration data to which utterance lengths are applied, as shown in FIG. 6. When transition sections are applied to the phonetic value configuration data, the stress-based phonetic value application unit 130 reconfigures phonetic value configuration data into phonetic value configuration data to which stress-based detailed phonetic values are applied, by incorporating the stresses of the respective phonetic values into the phonetic value configuration data to which transition sections and utterance lengths are applied, as shown in FIG. 7.

The stress-based phonetic value application unit 130 may detect the stresses of the respective phonetic values using the input voice information and may apply the detected stresses as the stress-based detailed phonetic values of respective phonetic values. The stress-based phonetic value application unit 130 may detect the stresses of respective phonetic values of the text information from text information and corresponding voice information, input through the input unit 110, and may apply stress-based detailed phonetic values. In this case, the stress-based phonetic value application unit 130 divides the section of the voice information for respective phonetic values depending on the utterance lengths of respective phonetic values detected by the phonetic value configuration data generation unit 120, measures the average energy or pitch value of the corresponding section, and extracts pieces of stress information of respective phonetic values. Here, the stress-based phonetic value application unit 130 may detect the pieces of stress information of respective phonetic values from the phonetic value information storage unit 135.

Here, the stress-based phonetic value application unit 130 applies stress-based detailed phonetic values to all vowels (for example, ae, e, i, o, etc.). The stress-based phonetic value application unit 130 applies stress-based detailed phonetic values even to vocalic consonants (for example, r, l, y, w, sh, etc.). The stress-based phonetic value application unit 130 may apply stress-based detailed phonetic values that are applied to non-vocalic consonants (b, k, t, etc.) depending on the stress of an adjacent subsequent phonetic value (that is, a subsequent vowel). For example, the stress-based phonetic value application unit 130 applies stress ‘0’ to the phonetic values /b/ and /d/ of the phonetic value configuration data ‘bred’ to which transition sections are assigned according to the voice information input from the user, applies ‘1’ to /r/, and applies ‘2’ to /e/. In this case, the phonetic value /r/ is a vocalic consonant, and stress ‘1’ is applied to /r/ due to the influence of the phonetic value /e/ appearing subsequent to /r/.

The stress-based phonetic value information storage unit 135 stores the relative stresses of phonetic values. The stress-based phonetic value information storage unit 135 stores the relative stresses of phonetic values included in each of a plurality of words. Here, the relative stress denotes stress in a dictionary definition, and is configured such that a largest value is allocated to a phonetic value having the strongest stress, among phonetic values included in each word, and a smallest value is allocated to a phonetic value having the weakest stress. Values having relative magnitudes are allocated to other phonetic values by using the values allocated to the strongest stress and the weakest stress. For example, the stress-based phonetic value information storage unit 135 stores the relative stresses of phonetic values /i/, /n/, /t/, /r/, /e/, /s/, and /t/ included in the word ‘intrest’. In this case, the stress-based phonetic value information storage unit 135 allocates a value of 2 to /i/ corresponding to stress in a dictionary definition, and allocates a value of 1 to /n/, /t/, /r/, /e/, /s/, and /t/. In this case, the stress-based phonetic value information storage unit 135 stores pieces of stress-based phonetic value information for the word ‘interest,’ as shown in the following Table 2.

TABLE 2

| | Phonetic | Phonetic | Phonetic | Phonetic | Phonetic | Phonetic | Phonetic |
|---|---|---|---|---|---|---|---|
| word | value 1 | value 2 | value 3 | value 4 | value 5 | value 6 | value 7 |
| interest | i_2 | n_1 | t_1 | r_1 | e_1 | s_1 | t_1 |

In this case, when the apparatus for generating a vocal organ animation using the stress of phonetic values includes the transition section assignment unit 180, which will be described later, the pronunciation form information storage unit 145 stores information about the pronunciation forms of respective transition sections. Here, the pronunciation form information of each transition section denotes information about the movement form of each articulator appearing between two pronunciations when a first detailed phonetic value and a second detailed phonetic value are continuously pronounced. The pronunciation form information storage unit 145 may store two or more pieces of pronunciation form information as pronunciation form information about a specific transition section or may not store pronunciation form information itself

The pronunciation form detection unit 140 detects pronunciation form information corresponding to a detailed phonetic value included in phonetic value configuration data to which stress-based detailed phonetic values are applied. In this case, the pronunciation form detection unit 140 detects the pronunciation form information having stress information having a smallest stress difference from the stress information of each phonetic value included in the phonetic value configuration data, among a plurality of pieces of pronunciation form information stored in the pronunciation form information storage unit 145, as the pronunciation form information of the corresponding phonetic value. For example, it is assumed that the pronunciation form information storage unit 145 stores stress information and images so that, for the phonetic value /a/, stress information ‘1’ and ‘image 1’, and stress information ‘5’ and ‘image 2’ are respectively associated with each other. When the stress information of the phonetic value /a/ included in the phonetic value configuration data is set as 2, the pronunciation form detection unit 140 detects ‘image 1’ associated with stress information ‘1’ as the pronunciation form information of the phonetic value /a/ from the pronunciation form information storage unit 145.

The pronunciation form detection unit 140 detects a stress difference between the stress information of phonetic values included in the phonetic value configuration data and the stress information of pieces of pronunciation form information stored in the storage unit. The pronunciation form detection unit 140 generates pronunciation form information corresponding to the detected stress difference using the pieces of pronunciation form information and sets the generated pronunciation form information as the pronunciation form information of the corresponding phonetic value. For example, it is assumed that, for the phonetic value /a/, stress information ‘1’ and ‘image 1’ in which an gap between the upper lip and the lower lip is set as about 1 cm, and stress information ‘3’ and ‘image 2’ in which an gap between the upper lip and the lower lip is set as about 3 cm are stored in the pronunciation form information storage unit 145. When the stress information of the phonetic value /a/ included in phonetic value configuration data is set as 2, the pronunciation form detection unit 140 generates an image in which an gap between the upper lip and the lower lip is set as about 2 cm, and sets the image as the pronunciation form information of the corresponding phonetic value.

The pronunciation form information storage unit 145 stores a plurality of pieces of pronunciation form information about a plurality of phonetic values. In this case, the pronunciation form information storage unit 145 stores the pronunciation form information so that at least one piece of pronunciation form information having pieces of different stress information is associated with each of a plurality of phonetic values.

The pronunciation form information storage unit 145 stores pronunciation form information so that at least one piece of pronunciation form information is associated with each phonetic value according to the stress information as the pronunciation form information of each phonetic value. The pronunciation form information storage unit 145 stores a representative image of an articulator or a vector value that is a basis for generating the representative image, as the pronunciation form information. Here, the pronunciation form information denotes information about the shape of an articulator, such as mouth, tongue, jaws, oral cavity, soft palate, hard palate, nose, or uvula when a phonetic value is uttered.

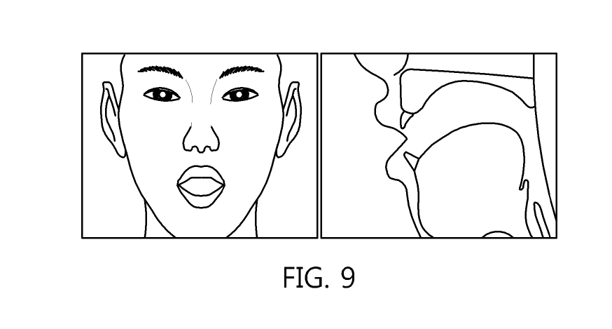

The pronunciation form information storage unit 145 stores pronunciation form information corresponding to stress-based detailed phonetic values. That is, the pronunciation form information storage unit 145 may store different pieces of pronunciation form information for a single phonetic value depending on stresses. For example, for a single phonetic value, the pronunciation form information storage unit 145 stores both pronunciation form information in which the shape of the mouth is widely opened (for example, an image of FIG. 8) when the stress is strong, and pronunciation form information in which the shape of the mouth is narrowly opened (for example, an image of FIG. 9) when the stress is weak.

The animation adjustment unit 150 provides an interface allowing the user to reset a phonetic value list indicating the sound values of input text information, the utterance lengths of respective phonetic values, transition sections assigned between phonetic values, a detailed phonetic value list included in the phonetic value configuration data, the utterance lengths of respective detailed phonetic values, pieces of stress-based phonetic value information, transition sections assigned between detailed phonetic values, or the pronunciation form information. The animation adjustment unit 150 provides an interface enabling a vocal organ animation to be adjusted to the user, and inputs reset information corresponding to one or more of individual phonetic values included in the phonetic value list, the utterance lengths of respective phonetic values, transition sections assigned between phonetic values, detailed phonetic values, the utterance lengths of respective detailed phonetic values, transition sections assigned between detailed phonetic values, pieces of stress-based phonetic value information, and pronunciation form information, from the user via the input unit 110.

In other words, the user resets individual phonetic values included in the phonetic value list, the utterance length of a specific phonetic value, transition sections assigned between phonetic values, detailed phonetic values included in the phonetic value configuration data, the utterance lengths of respective detailed phonetic values, transition sections assigned between detailed phonetic values, pieces of stress-based phonetic value information, or pronunciation form information, through an input means, such as a mouse or a keyboard. In this case, the animation adjustment unit 150 checks the reset information input by the user, and selectively transfers the reset information to the phonetic value configuration data generation unit 120, the transition section assignment unit 180, the stress-based phonetic value application unit 130, or the pronunciation form detection unit 140.

The animation adjustment unit 150 is configured to, when reset information related to individual phonetic values constituting the sound value of text information or reset information related to the utterance length of a phonetic value is input, transfer the reset information to the phonetic value configuration data generation unit 120, and the phonetic value configuration data generation unit 120 regenerates phonetic value configuration data by reflecting the reset information.

The animation generation unit 160 assigns the detected pronunciation form information to respective phonetic values constituting words included in text information, and then generates a vocal organ animation corresponding to the words included in the text information. That is, the animation generation unit 160 assigns respective pieces of pronunciation form information as key frames based on the utterance lengths of respective phonetic values (that is, detailed phonetic values) included in the phonetic value configuration data, transition sections, and stress-based detailed phonetic values. The animation generation unit 160 interpolates between the respective assigned key frames using an animation interpolation technique, and then generates a vocal organ animation corresponding to the text information. That is, the animation generation unit 160 assigns pieces of pronunciation form information corresponding to each detailed phonetic value as key frames at an utterance start time and at an utterance end time corresponding to the utterance length of the corresponding detailed phonetic value. The animation generation unit 160 interpolates between two key frames assigned based on the start time and end time of the utterance length of the detailed phonetic value, and thus generates a normal frame at an empty location between the key frames.

The animation generation unit 160 individually assigns pronunciation form information for each transition section as a key frame at the middle time of the corresponding transition section. The animation generation unit 160 interpolates between the key frame of the assigned transition section (that is, pronunciation form information for the transition section) and a key frame assigned previous to the transition section key frame. The animation generation unit 160 interpolates between the key frame of the transition section and a key frame assigned subsequent to the transition section key frame, and then generates a normal frame at an empty location within the corresponding transition section.

The animation generation unit 160 is configured to, when the number of pieces of pronunciation form information for a specific transition section is two or more, assign respective pieces of pronunciation form information to the transition section so that the pieces of pronunciation form information are spaced apart from each other at regular time intervals. The animation generation unit 160 interpolates between the corresponding key frame assigned to the transition section and its adjacent key frame, and generates a normal frame at an empty location within the corresponding transition section. In this case, the animation generation unit 160 is configured to, when pronunciation form information for a specific transition section is not detected by the pronunciation form detection unit 140, interpolate between pieces of pronunciation form information of two detailed phonetic values adjacent to the transition section and generate a normal frame to be assigned to the transition section, without assigning the pronunciation form information to the corresponding transition section.

The output unit 170 outputs one or more of the phonetic value list indicating the sound value of input text information, the utterance lengths of respective phonetic values, transition sections assigned between phonetic values, a detailed phonetic value list included in the phonetic value configuration data, the utterance lengths of respective detailed phonetic values, pieces of stress-based phonetic value information, and transition sections assigned between detailed phonetic values, together with the vocal organ animation, to a display means, such as a liquid crystal display. In this case, the output unit 170 may output the voice information of a native speaker corresponding to the text information via a speaker unit.

Here, as shown in FIG. 10, the apparatus for generating a vocal organ animation using stress may further include a vocal organ assignment unit 190 and a vocal organ information storage unit 195.

The vocal organ assignment unit 190 extracts phonetic symbols corresponding to the respective detailed phonetic values of phonetic value configuration data from the vocal organ information storage unit 195 so that the phonetic symbols are classified for respective vocal organs. The vocal organ assignment unit 190 checks utterance lengths and stresses for respective detailed phonetic values included in the phonetic value configuration data, and assigns utterance lengths for respective articulation symbols so that they correspond to the utterance lengths and stresses for respective detailed phonetic values. When the degrees of participation of respective articulation symbols in utterance are stored in the form of utterance lengths in the vocal organ information storage unit 195, the vocal organ assignment unit 190 extracts utterance lengths for respective articulation symbols from the vocal organ information storage unit 195, and assigns utterance lengths of the corresponding articulation symbols based on the extracted utterance lengths.

The vocal organ assignment unit 190 combines respective articulation symbols with the utterance lengths and stresses of the respective articulation symbols and generates articulation configuration data for the corresponding articulator, wherein transition sections are assigned to the articulation configuration data in correspondence with the transition sections included in the phonetic value configuration data. Meanwhile, based on the degrees of articulation symbols included in the articulation configuration data participating in utterance, the vocal organ assignment unit 190 may reset the utterance lengths of respective articulation symbols or the lengths and stresses of respective transition sections.

The vocal organ information storage unit 195 stores phonetic symbols corresponding to detailed phonetic values so that they are classified depending on respective vocal organs. The phonetic symbols are obtained by representing the states of respective vocal organs by identifiable symbols when detailed phonetic values are uttered by the vocal organs. The vocal organ information storage unit 195 stores phonetic symbols corresponding to the phonetic values for respective vocal organs. Preferably, the vocal organ information storage unit 195 stores articulator-based articulation symbols including the degrees of participation in utterance in consideration of previous or subsequent phonetic values and stresses. When a description is made by way of detailed example, in a case where phonetic values /b/ and /r/ are continuously uttered, the lips of the vocal organs mainly participate in the utterance of the phonetic value /b/ and the tongue mainly participates in the utterance of the phonetic value /r/. Therefore, when the phonetic values /b/ and /r/ are continuously uttered, the tongue of the vocal organs participates in advance in the utterance of the phonetic value /r/ even while the lips of the vocal organs are participating in the utterance of the phonetic value /b/. The vocal organ information storage unit 195 stores phonetic symbols including the degrees of participation in utterance in consideration of such previous or subsequent phonetic values.

In consideration of a tendency that if, upon distinguishing two phonetic values, the function of a specific vocal organ is remarkably important and the functions of the remaining vocal organs are unimportant and similar to each other, the vocal organ having an unimportant function and having a similar pronunciation form pronounces similar phonetic values while pushing them to any one side depending on the economy of pronunciation when the two phonetic values are continuously uttered, the vocal organ information storage unit 195 changes a phonetic symbol for a vocal organ having an unimportant function and having a similar pronunciation form in two successive phonetic values to a subsequent phonetic symbol and stores changed information. For example, when a phonetic value /f/ appears subsequent to a phonetic value /m/, a decisive function for distinguishing the phonetic values /m/ and /f/ from each other is performed by the uvula (the soft palate), and the lips performs a relatively unimportant function and the pronunciation forms of the phonetic values are similar to each other, so that when the phonetic value /m/ is uttered, the lips have a tendency to maintain the shape thereof at a shape in which the phonetic value /f/ is to be uttered. In this way, the vocal organ information storage unit 195 classifies different phonetic symbols for respective vocal organs depending on previous or subsequent phonetic values, even for the same phonetic value, and stores the phonetic symbols.

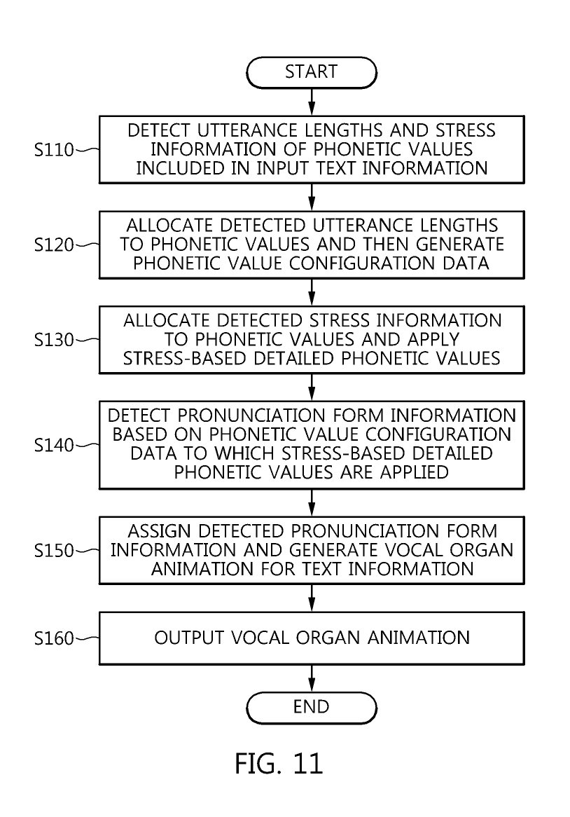

Hereinafter, a method of generating a vocal organ animation using the stress of phonetic values according to an embodiment of the present invention will be described in detail with reference to the attached drawing. FIG. 11 is a diagram showing a method of generating a vocal organ animation using the stress of phonetic values according to an embodiment of the present invention.

First, the utterance lengths and stress information of phonetic values included in input sentence information are detected (S110). In this case, the detection of the utterance lengths of the phonetic values is performed by the phonetic value configuration data generation unit 120. That is, the phonetic value configuration data generation unit 120 detects the utterance lengths of respective phonetic values from voice information input together with text information, via speech analysis technology. When only text information is input, the phonetic value configuration data generation unit 120 may detect the utterance lengths of respective phonetic values from the phonetic value information storage unit 125.

Next, the detected utterance lengths are allocated to the phonetic values included in the text information, and then phonetic value configuration data is generated (S120). That is, the phonetic value configuration data generation unit 120 generates phonetic value configuration data by applying the utterance lengths of respective phonetic values detected at step S110 to the respective phonetic values of the text information. Here, the transition section assignment unit 180 may assign transition sections to the phonetic value configuration data.

The detection of stress information of the phonetic values is performed by the phonetic value configuration data generation unit 120 or the stress-based phonetic value application unit 130. That is, the phonetic value configuration data generation unit 120 or the stress-based phonetic value application unit 130 divides the section of voice information for phonetic values depending on the detected utterance lengths of the respective phonetic values, measures the average energy or pitch value of the corresponding section, and extracts pieces of stress information of respective phonetic values.

Next, the pieces of detected stress information are allocated to the phonetic values included in the text information, and then phonetic value configuration data is generated (S130). That is, the stress-based phonetic value application unit 130 allocates the detected stress information to the generated phonetic value configuration data and applies stress-based detailed phonetic values to the respective phonetic values. In this case, the stress-based phonetic value application unit 130 may use the stress information detected at the above-described step S110 or may directly detect stress information from the voice information and use the detected stress information. That is, the stress-based phonetic value application unit 130 may analyze voice information corresponding to text information input from the user through the input unit 110, detect the stresses of the respective phonetic values of the text information, and apply stress-based detailed phonetic values. In this case, the stress-based phonetic value application unit 130 divides the section of the voice information for phonetic values depending on the utterance lengths of respective phonetic values detected by the phonetic value configuration data generation unit 120, measures the average energy or the pitch value of the corresponding section, and extracts pieces of stress information of respective phonetic values. In this case, the stress-based phonetic value application unit 130 may detect the pieces of stress information of the respective phonetic values from the stress-based phonetic value information storage unit 135.

Accordingly, the phonetic value configuration data is reconfigured into phonetic value configuration data to which the pieces of stress information of the respective phonetic values are applied.

Thereafter, pieces of pronunciation form information for respective phonetic values included in the text information are detected based on the phonetic value configuration data to which the stress-based detailed phonetic values are applied (S140). In this case, the pronunciation form detection unit 140 detects pronunciation form information having stress information having a smallest stress difference from the stress information of each of the phonetic values included in the phonetic value configuration data, among a plurality of pieces of pronunciation form information stored in the pronunciation form information storage unit 145, as the pronunciation form information of the corresponding phonetic value.

Of course, the pronunciation form detection unit 140 may also generate pronunciation form information using the stored pronunciation form information and the stress information of the phonetic values. That is, the pronunciation form detection unit 140 detects a stress difference between the stress information of phonetic values included in the phonetic value configuration data and the stress information of the pronunciation form information stored in the storage unit. The pronunciation form detection unit 140 generates pronunciation form information based on the stress difference detected using the pronunciation form information, and sets the generated pronunciation form information as the pronunciation form information of the corresponding phonetic value.

Next, the pieces of detected pronunciation form information are allocated to the respective phonetic values included in the text information, and then a vocal organ animation for the text information is generated (S150). That is, the animation generation unit 160 assigns the pieces of pronunciation form information detected at step S140 to respective phonetic values constituting words included in the text information, and then generates a vocal organ animation corresponding to the words included in the text information. In greater detail, the animation generation unit 160 assigns pieces of pronunciation form information corresponding to each detailed phonetic value included in the phonetic value configuration data as key frames at start time and at end time of the corresponding detailed phonetic value, and additionally assigns pronunciation form information corresponding to each transition section as the key frame of the transition section. That is, the animation generation unit 160 assigns key frames so that the pronunciation form information of each detailed phonetic value is played by the corresponding utterance length and so that the pronunciation form information of each transition section is displayed only at a specific time within the corresponding transition section. Then, the animation generation unit 160 generates a normal frame at an empty location between key frames (that is, pronunciation form information) via an animation interpolation technique, and thus generates a single completed vocal organ animation. In this case, the animation generation unit 160 is configured to, when pronunciation form information corresponding to a specific transition section is not present, interpolate between pieces of pronunciation form information adjacent to the transition section and then generate a normal frame corresponding to the transition section. Meanwhile, the animation generation unit 160 is configured to, when the number of pieces of pronunciation form information corresponding to a specific transition section is two or more, assign respective pieces of pronunciation form information to the transition section so that the pieces of pronunciation form information are spaced apart from each other at regular time intervals, interpolate between the corresponding key frame assigned to the transition section and its adjacent key frame, and then generate a normal frame at an empty location within the corresponding transition section.

The output unit 170 outputs the generated vocal organ animation (S160). That is, the output unit 170 outputs the vocal organ animation generated with including utterance lengths, stress information, transition sections, etc. to a display means such as a liquid crystal display. In this case, the output unit 170 may output the voice information of the native speaker corresponding to the text information, together with the vocal organ animation, through a speaker unit.

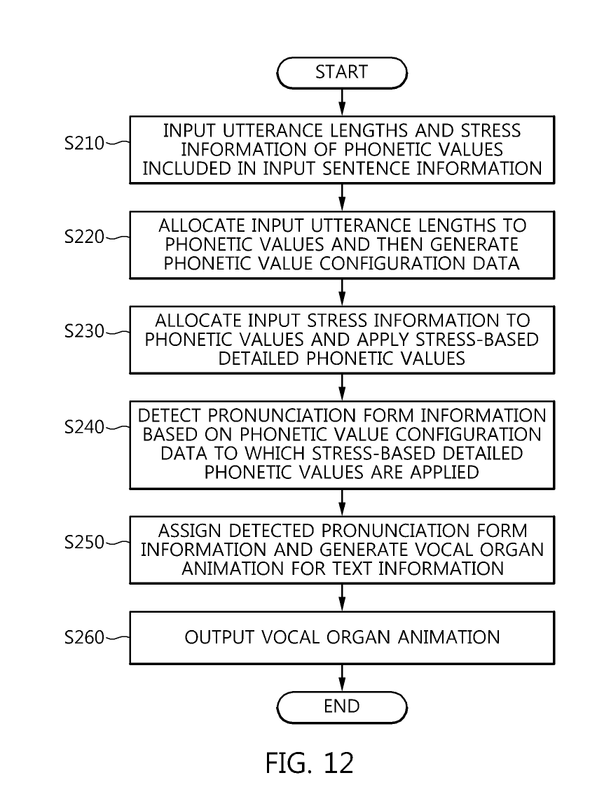

Hereinafter, a method of generating a vocal organ animation using the stress of phonetic values according to another embodiment of the present invention will be described in detail with reference to the attached drawing. FIG. 12 is a diagram showing a method of generating a vocal organ animation using the stress of phonetic values according to another embodiment of the present invention. A detailed description of steps identical to those of the above-described embodiment will be omitted.

First, the utterance lengths and stress information of phonetic values included in input sentence information are input (S210). That is, when only text information other than voice information is input from a user, the input unit 110 inputs the utterance lengths and stress information of respective phonetic values included in the text information from the user so as to generate phonetic value configuration data.

Next, the input utterance lengths are allocated to the phonetic values included in the text information, and then phonetic value configuration data is generated (S220). That is, the phonetic value configuration data generation unit 120 generates the phonetic value configuration data by applying the utterance lengths of respective phonetic values input at step S210 to the respective phonetic values of the text information. Here, the transition section assignment unit 180 may also assign transition sections to the phonetic value configuration data.

Thereafter, pieces of input stress information are allocated to the phonetic values included in the text information, and then phonetic value configuration data is generated (S230). That is, the stress-based phonetic value application unit 130 allocates the pieces of stress information of the respective phonetic values input through the input unit 110 to the previously generated phonetic value configuration data, and then applies stress-based detailed phonetic values to the respective phonetic values. Accordingly, the phonetic value configuration data is reconfigured into phonetic value configuration data to which the pieces of stress information of the respective phonetic values are applied.

Next, pieces of pronunciation form information for respective phonetic values included in the text information are detected based on the phonetic value configuration data to which the stress-based detailed phonetic values are applied (S240).

Then, the pieces of detected pronunciation form information are allocated to the respective phonetic values included in the text information, and then a vocal organ animation for the text information is generated (S250).

The output unit 170 outputs the generated vocal organ animation (S260).

As described above, the apparatus and method for generating a vocal organ animation using the stress of phonetic values are advantageous in that a vocal organ animation is generated by reflecting the pronunciation form of a native speaker that changes depending on the stress of phonetic values constituting a word, thus generating a vocal organ animation very close to the pronunciation form of the native speaker.

Further, the apparatus and method for generating a vocal organ animation using the stress of phonetic values are advantageous in that the movement process of the vocal organs is generated in the form of an animation and is then displayed, thus providing an environment in which a language learner can intuitively understand the pronunciation principles of a target language and a difference in pronunciation between a native speaker and the learner, and in which the learner can be naturally familiar with the pronunciation of all sounds of the corresponding language during a procedure for variously learning from basic phonetic values to sentences.

Furthermore, the apparatus and method for generating a vocal organ animation using the stress of phonetic values are advantageous in that an animation is generated based on pieces of pronunciation form information classified for respective articulators, such as lips, tongue, nose, uvula, palate, teeth, and gums, thus enabling a more accurate and natural vocal organ animation to be implemented.

As described above, although preferred embodiments of the present invention have been described, the present invention may be modified in various forms, and it should be understood that those skilled in the art may implement various modifications and changes without departing from the scope of the accompanying claims of the present invention.

1-12. (canceled)

13. An apparatus for generating a vocal organ animation using stress of phonetic values, comprising:
a phonetic value configuration data generation unit for allocating utterance lengths to respective phonetic values constituting words included in text information and then generating phonetic value configuration data;
a stress-based phonetic value application unit for allocating stress information to the generated phonetic value configuration data and applying stress-based detailed phonetic values to the respective phonetic values;
a pronunciation form detection unit for detecting pieces of pronunciation form information corresponding to detailed phonetic values included in the phonetic value configuration data to which the stress-based detailed phonetic values are applied; and
an animation generation unit for assigning the pieces of detected pronunciation form information to the respective phonetic values constituting the words included in the text information, and then generating a vocal organ animation corresponding to the words included in the text information.

14. The apparatus of claim 13, wherein:
the phonetic value configuration data generation unit detects utterance lengths and stress information of the respective phonetic values constituting the words included in the text information from voice information input together with the text information, allocates the detected utterance lengths to the respective phonetic values constituting the words included in the text information, and then generates the phonetic value configuration data, and
the stress-based phonetic value application unit allocates the stress information detected by the phonetic value configuration data generation unit to the generated phonetic value configuration data, and applies the stress-based detailed phonetic values to the respective phonetic values.

15. The apparatus of claim 13, further comprising:
a phonetic value configuration data generation unit for allocating input utterance lengths to respective phonetic values constituting words included in text information and then generating phonetic value configuration data; and
a stress-based phonetic value application unit for detecting utterance lengths and stress information of the respective phonetic values constituting the words included in the text information from voice information input together with the text information, and allocating input stress information to the phonetic value configuration data, and then applying the stress-based detailed phonetic values to the respective phonetic values;

16. The apparatus of claim 13, further comprising an input unit for inputting the utterance lengths and stress information of the respective phonetic values constituting the words included in the text information,
wherein the phonetic value configuration data generation unit allocates the input utterance lengths to the respective phonetic values constituting the words included in the text information and then generates the phonetic value configuration data, and
wherein the stress-based phonetic value application unit allocates the input stress information to the phonetic value configuration data, and applies the stress-based detailed phonetic values to the respective phonetic values.

17. The apparatus of claim 13, further comprising:
a phonetic value information storage unit for storing utterance lengths of a plurality of phonetic values; and
a stress-based phonetic value information storage unit for storing pieces of stress information of the plurality of phonetic values,
wherein the phonetic value configuration data generation unit detects utterance lengths of the respective phonetic values constituting the words included in the text information from the phonetic value information storage unit, allocates the detected utterance lengths, and then generates the phonetic value configuration data, and
wherein the stress-based phonetic value application unit detects the stress information of the respective phonetic values constituting the words included in the text information from the stress-based phonetic value information storage unit, allocates the detected stress information to the generated phonetic value configuration data, and applies the stress-based detailed phonetic values to the respective phonetic values.

18. The apparatus of claim 13, further comprising a pronunciation form information storage unit for storing a plurality of pieces of pronunciation form information for a plurality of phonetic values so that one or more pieces of pronunciation form information having pieces of different stress information are associated with each of the plurality of phonetic values,
wherein the pronunciation form detection unit is configured to detect pronunciation form information having stress information having a smallest stress difference from stress information of each phonetic value, among the one or more pieces of pronunciation form information associated with each phonetic value, as pronunciation form information of the phonetic value.

19. The apparatus of claim 13, further comprising a pronunciation form information storage unit for storing pronunciation form information so that pieces of pronunciation form information having stress information are associated with each of a plurality of phonetic values,
wherein the pronunciation form detection unit detects a stress difference between the stress information of the phonetic values included in the phonetic value configuration data and stress information of the pieces of pronunciation form information stored in the storage unit, generates pronunciation form information depending on the stress difference, and sets generated pronunciation form information as pronunciation form information of a corresponding phonetic value.

20. The apparatus of claim 13, further comprising a transition section assignment unit for assigning a part of utterance lengths of two neighboring phonetic values included in the phonetic value configuration data as a transition section between the two phonetic values.

21. A method of generating a vocal organ animation using stress of phonetic values, comprising:
allocating utterance lengths corresponding to respective phonetic values constituting words included in text information to corresponding phonetic values and then generating phonetic value configuration data;
allocating pieces of stress information corresponding to respective phonetic values included in the generated phonetic value configuration data and applying stress-based detailed phonetic values to the phonetic value configuration data;
detecting pieces of pronunciation form information corresponding to the stress-based detailed phonetic values included in the phonetic value configuration data to which the stress-based detailed phonetic values are applied; and
assigning the pieces of detected pronunciation form information to the respective phonetic values, and then generating a vocal organ animation corresponding to the words included in the text information.

22. The method of claim 21, further comprising detecting the utterance lengths and stress information of the respective phonetic values constituting the words included in the text information.

23. The method of claim 22, wherein generating the phonetic value configuration data is configured to allocate the detected utterance lengths to the corresponding phonetic values and then generate the phonetic value configuration data.

24. The method of claim 22, wherein applying the stress-based detailed phonetic values is configured to allocate the detected stress information of the phonetic values to the respective phonetic values included in the generated phonetic value configuration data and then apply the stress-based detailed phonetic values to the phonetic value configuration data.

25. The method of claim 22, wherein detecting the utterance lengths and stress information comprises any one of:
detecting the utterance lengths and the stress information from voice information input together with the text information; and
detecting utterance lengths and stress information corresponding to the respective phonetic values constituting the words included in the text information from a plurality of pre-stored phonetic values.

26. The method of claim 21, further comprising inputting utterance lengths and stress information of the respective phonetic values constituting the words included in the text information.

27. The method of claim 26, wherein generating the phonetic value configuration data is configured to allocate input utterance lengths of the respective phonetic values to corresponding phonetic values, and then generate the phonetic value configuration data.

28. The method of claim 26, wherein applying the stress-based detailed phonetic values is configured to allocate pieces of detected stress information of the phonetic values to the respective phonetic values included in the input phonetic value configuration data and apply the stress-based detailed phonetic values to the phonetic value configuration data.

29. The method of claim 21, wherein detecting the pronunciation form information is configured to:
detect pronunciation form information having stress information having a smallest stress difference from stress information of each phonetic value, among one or more pieces of pronunciation form information associated with each phonetic value, as pronunciation form information of the corresponding phonetic value, or
generate pronunciation form information depending on a stress difference between the stress information of the phonetic values included in the phonetic value configuration data and stress information of pieces of pre-stored pronunciation form information, and set the generated pronunciation form information as pronunciation form information of the corresponding phonetic value.

30. The method of claim 21, further comprising assigning a part of utterance lengths of two neighboring phonetic values among phonetic values included in any one of phonetic value configuration data to which utterance lengths are allocated and phonetic value configuration data to which stress-based detailed phonetic values are applied, as a transition section between the two phonetic values.
